(19) United States
(12) Patent Application Publication
(10) Pub. No.: US 2016/0249126 A1
(43) Pub. Date: Aug. 25, 2016

(54) PERSONALIZED HEADPHONES

(71) Applicant: HARMAN INTERNATIONAL INDUSTRIES, INC., Stamford, CT (US)

(72) Inventors: Srikanth KONJETI, Bangalore (IN); Vallabha Vasant HAMPIHOLI, Bangalore (IN); Karthik VENKAT, Bengaluru (IN)

(21) Appl. No.: 14/627,461

(22) Filed: Feb. 20, 2015

(51) Int. Cl. H04R 1/10

(52) U.S. Cl. CPC H04R 1/1041; H04R 1/1091

(57) ABSTRACT

A headphone listening device may include a first speaker and a second speaker interconnected by a head support, at least one sensor configured to detect a speaker displacement of the first speaker relative to the second speaker, and a controller configured to apply at least one speaker attribute to at least one of the first speaker and second speaker based on the speaker displacement.

### TECHNICAL FIELD

Embodiments disclosed herein generally relate to a headphone system and method.

### BACKGROUND

Headphones are often used by a user to listen to audio and typically come equipped with certain audio processing defaults, such as maximum volume limits, equalization settings, etc. Often times, headphones are shared among a group of people, such as family and friends. This is especially the case with high-quality headphones. However, the default settings established at manufacturing may not provide for an optimal listening experience for each and every user. That is, because the user may be one of a child or adult, each with different hearing capabilities, the listening experience provided by the default settings may not cater to the individual that is currently using the headphones.

### SUMMARY

A headphone listening device may include a first speaker and a second speaker interconnected by a head support, at least one sensor configured to detect a speaker displacement of the first speaker relative to the second speaker, and a controller configured to apply at least one speaker attribute to at least one of the first speaker and second speaker based on the speaker displacement.

A headphone listening device may include at least one speaker, a sensor configured to generate a first sensor value indicative of a head size of a user, and a controller configured to compare the first sensor value to a stored sensor value, apply at least one speaker setting associated with the stored sensor value in response to the first sensor value matching the stored sensor value.

A non-transitory computer-readable medium tangibly embodying computer-executable instructions of a software program, the software program being executable by a processor of a computing device may provide operations for receiving a first sensor value, comparing the first sensor value with a stored sensor value, selecting a profile associated to the store sensor value in response to the first sensor value matching the stored sensor value, and transmitted at least one speaker setting defined by the profile of the stored sensor value.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates a headphone listening device in accordance with one embodiment;

FIG. 2 illustrates a block diagram for the headphone listening device in accordance with one embodiment;

FIG. 3 illustrates a look-up table for the headphone listening device in accordance with one embodiment; and

FIG. 4 illustrates a process flow of the headphone listening device in accordance with one embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Described herein is a headphone listening device programmed to apply personalized speaker settings during use by a specific individual. For example, often times higher-end headphones are shared among family members and friends, including adults and children. Specific speaker settings or attributes may be applied based on sensor data indicative of the head size of the user, thus indicating a perceived age of the user. For example, the profile settings for a child may differ from the profile settings of an adult in an effort to provide a better listening experience for each classification of user. In addition to standard profiles that are applied based on the perceived age of the user, personalized profiles may be generated for specific users. In one example, the profile for one user may account for a hearing deficiency of that user (e.g., the gains at certain frequencies may be increased). Thus, a personalized headphone listening device is disclosed herein to provide an enhanced listening experience for each user.

FIG. 1 illustrates a headphone listening device 100, also referred to as “headphones 100”. The headphones 100 include at least one speaker device 110, or “speakers 110”. The headphones 100 may receive an audio signal from an audio device (not shown) for audio playback at the speakers 110. The audio device may be integrated into the headphones 100 and may also be a separate device configured to transmit the audio signal either via a hardwired connection such as a cable or wire and as well as via a wireless connection such as a cellular, wireless or Bluetooth network, for example. The audio device may be, for example, a mobile device such as a cell phone, an iPod®, notebook, personal computer, media server, etc.

In the example in FIG. 1, the headphones 100 include two earpieces 105 each housing a speaker device 110 and being interconnected by a head support 120, or “support 120”. The head support 120 may be a flexible or adjustable piece connecting the two speakers 110. The head support 120 may provide for support along a user's head to aid in maintaining the headphone's position during listening. The head support 120 may also provide a clamping or spring-like tension so as to permit the speakers 110 to be frictionally held against a user's ear. The head support 120 may be flexible and may be made out of a flexible material such as wire or plastic, to permit movement of the wire during placement and removal of the headphones 100 from the user's head. Additionally, the head support 120 may be adjustable in that the length of the support 120 may be altered to fit a specific user's head. In one example, the head support 120 may include a telescoping feature where a first portion 125 may fit slidably within a second portion 130 to permit the first portion 125 to move into and out of the second portion 130 according to the desired length of the support 120.

The length of the support 120 may vary depending on the size of the user's head. For example, a child may adjust the support 120 to be shorter while an adult may adjust the support 120 to be longer. The headphones 100 may include at least one first sensor 135 capable of determining the length of the support 120. For example, the first sensor 135 may be a position sensor capable of determining how far extended the first portion 125 of the telescoping feature is relative to the second portion 130. In the example shown in FIG. 1, a pair of first portions 125 may be slidable within the second portion 130 and a pair of first sensors 135 may be used, one at each first portion 125, to determine the relative length of the support 120.

Additionally or alternatively, a second sensor 140 may be included in the headphones 100. The second sensor 140 may be position within or at the speakers 110. The second sensor 140 may be configured to determine the size of the user's head. In one example, the second sensor 140 may be a gyroscope configured to determine an angular offset of the speakers 110 and/or ear cup. The angular offset may correlate to the size of a user's head. That is, the larger the offset, the larger the head and visa-versa. Thus, sensors 134, 140 may be used to determine a displacement of the speakers 110 relative to one another, either via the angular offset, or the length of the support 120.

The headphones 100 may include a microphone 145 configured to receive sound, or audio signals. These audio signals may include ambient noise as well as audible sounds and commands from the user. The microphone 145 may receive audible responses from the user in response to audible inquiries made via the speakers 110. This may be the case when a hearing test is being performed. The user may hear certain questions, such as “Can you hear this sound?” at the speakers 110 and respond audibly with a “yes” or “no” answer.

Additionally, the headphones 100 may be configured to adjust the head support 120 in response to audible commands from the user. For example, the user may instruct the headphones to “Tighten the head support.” In response to the command, a controller may instruct the head support 120 to shorten, or lengthen via a motor or other mechanism (not shown), depending on the command.

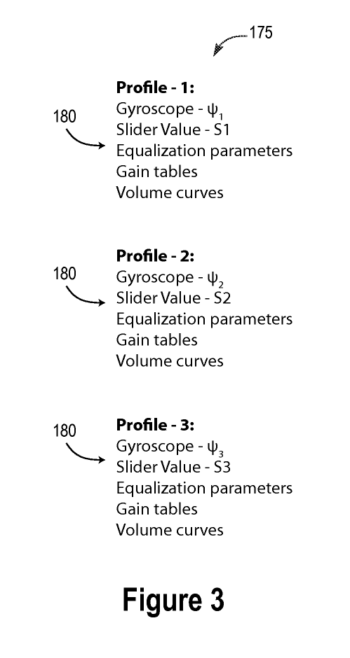

The headphones 100 may also include a user interface 115, such as a switch or panel, configured to receive commands or feedback from the user. The interface 115 may indicate a specific mode of the headphones 100, as discussed herein with respect to FIG. 3. The interface 115 may also be configured to receive instructions relating to the volume level of the speakers 110 from the user. Further, the interface 115 may be implemented at a device separate from the headphones 100 such as at a cellular phone, tablet, etc. In this example, the headphones 100 may communicate with the remote device via wireless communication facilitated via an application on the device. For example, an application on a user's cellular phone may provide the interface 115 configured to provide commands to the headphones 100.

The headphones 100 may be powered by a re-chargeable or replaceable battery. In the example of the re-chargeable battery, the battery may be recharged via an external power source connectable via a Universal Serial Bus (USB) connection. The headphones 100 may also be powered by an AC wired power source such as a standard wall outlet.

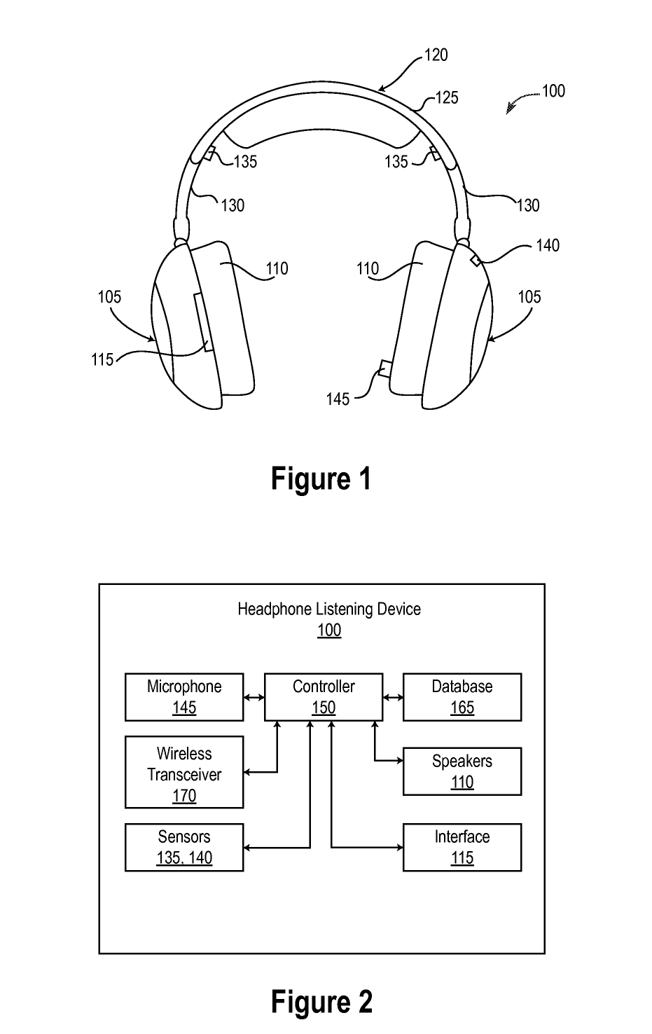

FIG. 2 illustrates a block diagram of the headphone device 100. The headphones 100 may include a controller 150 configured to facilitate the listening experience for the user. The controller 150 may be in communication with a database 165, the microphone 145, the user interface 115 and speakers 110. The controller 150 may also be in communication with the sensors 135, 140 and a wireless transceiver 170. The transceiver 170 may be capable of receiving signals from remote devices, such as the audio devices and providing the signals to the controller 150 for playback through the speakers 110. Other information and data may be exchanged via the transceiver 170 such as user settings, playlists, settings, etc. Communications between the headphones 100 and the remote device may be facilitated via a Bluetooth® network or over Wi-Fi®. Bluetooth® or Wi-Fi® may be used to stream media content, such as music from the mobile device to the headphones 100 for playback. The controller 150 may include audio decoding capabilities for Bluetooth® technology.

The microphone 145 may provide audio input signals to the controller 150. The audio input signal may include samples of ambient noise which may be analyzed by the controller 150. The controller 150 may adjust the audio output based on the input samples to provide for a better listening experience (e.g., noise cancellation).

The database 165 may be located locally within the headphones 100 and may include at least one look-up table 175 including a plurality of profiles cataloged by stored displacement values (e.g., sensor values of the gyroscope and slider.) The database 165 may also be located on the remote user device, or other location.

The sensors 135, 140, as described above, may include sensors capable of generating a sensor valve indicative of the size of a user's head, either by sensing the length of the head support 120 and/or an angular offset at one or more speakers 110. The sensors 135, 140 may also include position sensors capable of determining a distance between the two speakers 110.

Hearing capabilities are not constant or equal for all users. The ability to hear various frequencies varies with user age and gender. By gathering data via the sensors 135, 140 regarding the size of a user's head, the data may indicate the age and/or gender of the user. The controller 150 may receive sensor data having a sensor value indicative of the user's head size from the sensors 135, 140 so that the controller 150 may analyze the data and compare the sensor value to the stored values in look-up table 175 in an effort to classify the user based on the user's head size. For example, a certain angular offset detected by the second sensor 140 may be aligned with a saved offset value in the look-up table 175 corresponding to a child's head size. The controller 150, in response to determining a classification for the current user, may apply speaker settings, also defined in the corresponding profile 180, to the speakers 110. These settings may include specific volume limits (e.g., a maximum volume), gain values, equalization parameters/profiles, etc. In the example of a child, while the volume may be adjustable at the headphones 100, a limit may be imposed to protect the child's hearing. Higher volume limits may be imposed for adult users. In another example, if the user's gender is determined to be female, different gain values may be established that differ from those gain values of a male user due to the differing hearing abilities among genders.

The controller 150 may determine a user's classification based data from one or more sensor 135, 140. For example, the appropriate profile 180 may be determined based on data from the first sensor 135 only, data from the second sensor 140 only, or data from both the first sensor 135 and the second sensor 140. The more data used to determine the profile/classification, the more accurate the determination.

FIG. 3 illustrates a look-up table 175 within the database 165 having a plurality of profiles 180. As explained, each profile 180 may include preset speaker settings relating to the sound transmitted via the speakers 110, such as equalization parameters, gain tables, column limits and curves, etc. The profiles 180 may include attributes corresponding to a type of user. For example, a user may be classified as a child or an adult. While the examples herein relate predominately to the age of the user, the user may be classified based on other characteristics outside of age such as geographic location, gender, race, etc. At least one look-up table 175 may include a plurality of profiles, each corresponding to a user classification.

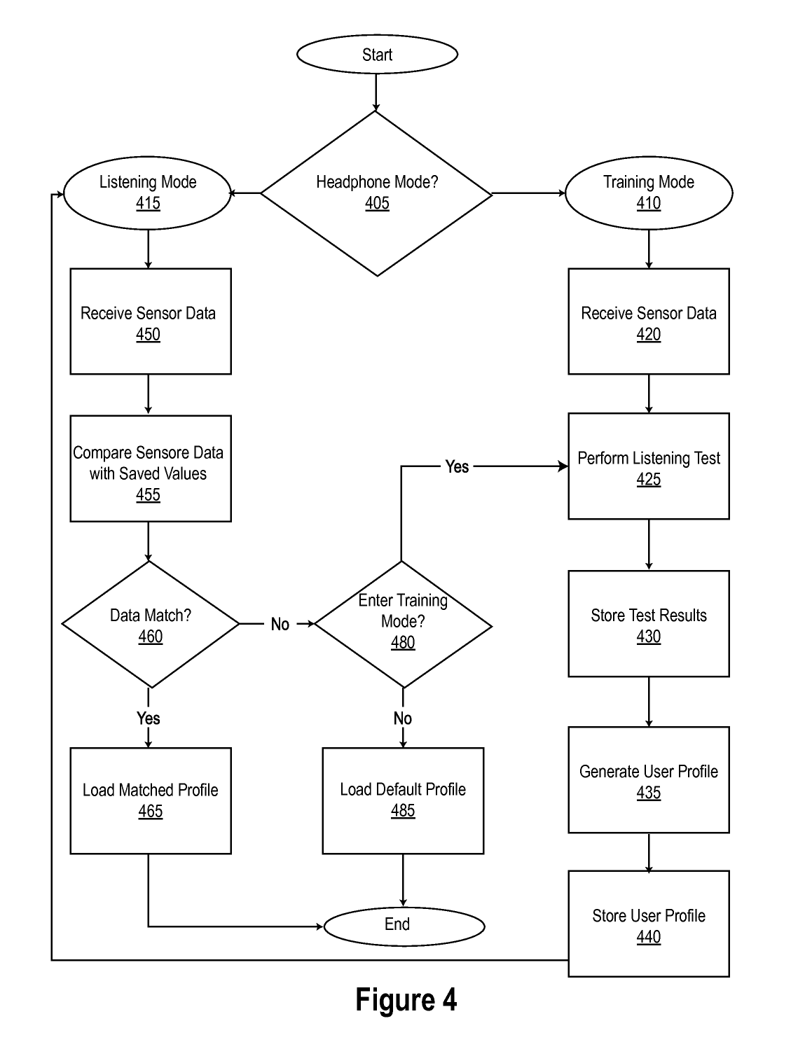

The profiles 180 may be standard profiles configured to apply speakers settings based on a user's perceived age. However, the profiles 180 may also be personalized profiles generated for a specific user in response to a user's specific needs. For example, one user may have difficulty hearing higher frequencies. For this user, the gain at these frequencies may be increased. These personalized profiles may include speaker settings such as a volume curve, frequency vs. gain curve, maximum volume, minimum value, default volume, etc. The speaker setting may also include other settings related to the speaker tone settings such as base and treble settings. The personalized profiles may be applied each time the controller 150 recognizes the specific user based on the sensor value within the sensor data. The personalized profiles may be generated in response to hearing tests performed at the headphones 100. That is, the best speaker settings for a user's hearing ability may be established. Moreover, if two users have similar head sizes, the speakers 110 may, in response to a command from the controller 150, ask the user for his or her name. The response by the user may be picked up by the microphone 145 and the controller 150 may apply the respective profile for the user. These processes are described in more detail below with respect to FIG. 4.

Returning to FIG. 2, the interface 115 may transmit commands and information to the controller 150. The interface 115 may be a switch, a liquid crystal display, or any other type of interface configured to receive user commands. The transmitted commands may be related to playback of the audio and may include volume commands, as well as play commands such skip, fast forward, etc. The commands may also include a mode command. In one example, the headphones 100 may be configured to operate in a normal listening mode where the user listens to audio as is a typical use of headphones 100. In another mode, a training mode, the headphones 100 may establish certain parameters relating the user. The parameters may include data indicative of the user's head size based on acquired sensor data (i.e., the sensor value). Additionally or alternatively, the headphones 100 may also gather user information relating to the user's hearing capabilities by performing hearing tests. The results of the hearing test may affect the preset speaker settings relating to the specific user. That is, a personalized profile 180 may be created for that user so that the profile 180 and included speaker settings are specific to that user. This is described in more detail in FIG. 4 below.

FIG. 4 illustrates a process 400 of operation for the controller 150 based on a speaker mode. The process 400 may begin at block 405 where the processor may determine whether the headphones 100 are in a listening mode or a training mode. This determination may be made based on the mode command transmitted to the controller 150 from the interface 115. Additionally or alternatively, the mode may be determined based on other factors not related to user input at the interface 115. These factors may include whether the headphones 100 are being used for a first time, e.g., they have just been turned on for the first time since being manufactured.

If the headphones 100 are determined to be in training mode, the process 400 proceeds to block 410, if not, the process 400 proceeds to listening mode at block 415.

In training mode, the headphones 100 may be configured to gather data about the current user and develop a personalized profile 180 for that specific user. This profile 180 may then be applied to the speakers 110 anytime the specific user is recognized (via sensor data) as using the headphones 100 thus enhancing the listening experience for each user. At block 420, the controller 150 may receive sensor data. As explained above, the sensor data may include the sensor value to identify a user.

At block 425, the controller 150 may perform a listening test. The listening test may include a plurality of inquiries and received responses capable of building a personalized hearing profile based on the hearing capabilities of a specific user. The inquiries may include audible questions combined with specific tones directed to the user. For example, the inquiries may include questions such as “can you hear this tone?” or “at which ear do you hear this tone?” The responses may be made audibly by the user and received at the microphone 145. For example, the user may respond with “yes,” or “left ear.” The responses may also be received at the interface 115. In this example, the interface 115 may be a screen at the headphones 100 or at the remote device where the user selects certain responses from a list of possible responses.

During the listening test, the controller 150 may actively adjust certain gain characteristics based on the feedback of the user. For example, if a user indicates that he or she cannot hear a tone at a certain frequency, the gain for that frequency may be increased incrementally until the user indicates that he or she can hear the tone.

At block 430, the results of the listening test may be stored in the database 165.

At block 435, the controller 150 may analyze the results of the listening test to generate speaker settings based on the results. The speaker settings may include gain tables specific to the user's hearing abilities. For example, if the results indicate that the user has trouble hearing higher pitches, the gain for those frequencies may be decreased. In another example, the gain at one speaker 110 may differ from the other speaker 110, depending on the results to account for discrepancies in hearing at the left and right ears.

At block 440, the controller 150 stores the user profile 180, including the sensor values and speaker settings, in the database 165.

During the listening mode, while a specific user profile is not being generated, as is the case in the training mode, the headphones 100 may still determine which profile to apply based on sensor data. At block 450, the controller 150 may receive sensor data, similar to block 420.

At block 455, the controller 150 may compare the received sensor value within the sensor data with the stored sensor values (i.e., stored displacement values) in the look-up table 175 within the database 165.

At block 460, the controller 150 may determine whether the sensor data matches at least one saved sensor value within the look-up table 175. In order to “match” a saved value, the sensor data may be within a predefined range of one of the saved values. For example, if the sensor data is an angular offset/displacement, the sensor data may matched a saved value if it is within 0.5 degrees of the saved value. If the sensor data falls within the predefined range of several saved values, the controller 150 may select the saved value for which the sensor data is the closest match. Further, in the event that sensor data is gathered from more than one sensor 135, 140, a weighted determination may be made in an effort to match a profile using multiple data point. If a match is determined, the process 400 proceeds to block 465. If not, the process 400 proceeds to block 480.

At block 465, the controller 150 may load the profile 180 associated with the matched sensor data and apply the speaker settings defined in the profile 180. The matched profile, as explained, may be one of a standard profile or a personalized profile. The user may continue with normal use of the headphones 100.

At block 480, in response to the speaker data not matching a saved value, the controller 150 may determine whether to enter into the training mode and to create a profile. This determination may be made by the user after a prompt initiated by the controller 150. The prompt may include an audible inquiry made via the speakers 110 such as, “Would you like to generate a personalized profile?” Additionally or alternatively, the prompt may be made at the interface 115. If the user responds indicating that he or she would like to generate a personalized profile, the process 400 proceeds to block 425. Otherwise, the process 400 proceeds to block 485.

At block 485, the controller 150 may apply a default profile saved in the database 165. The default profile may include speaker settings safe for all users, regardless of their hearing ability, age, etc. For example, the volume limits may be appropriate for both a child and adult to ensure hearing safety regardless of the user's age. The default profile may also include standard gain settings.

The process 400 may then end.

While the sensor data may be used to identify a user profile, other data, such as user input, may also be used to pull up or identify a profile associated with a specific user. The user input may include voice commands received at the microphone 145. In this example, the user wearing the headphones 100 may give a verbal command such as “this is Bob.” The profile for Bob may then be pulled from the database 165 and applied. In another example, the user input may be received at the interface 115 where the user selects a certain profile. These user inputs may be used in addition to or in the alternative to the sensor data. For example, user inputs may be used to confirm the identity of the user. In another example, the user input may be used as the only indicator of the user identity. In this example, sensor data may be inaccurate due to factors that may skew the sensor data, for example, when the user is wearing a hat.

Accordingly, described herein is a method and apparatus for permitting certain speaker settings to be applied to headphones based on a user's head size. The user's head size may be indicative of a user's age, which may correlate to certain hearing characteristics. While a child's hearing may be better than that of an adult, children's ears may also be more sensitive to loud noise and thus the volume limits/level for a child user may be set lower than those for an adult user. In addition to applying a standard profile based on the user's perceived age, a personalized profile may be developed for a specific user such that the gain tables may be adjusted to a specific user's hearing needs.

Computing devices described herein generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

With regard to the processes, systems, methods, heuristics, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A headphone listening device, comprising:
a first speaker and a second speaker interconnected by a head support;
at least one sensor configured to detect a speaker displacement of the first speaker relative to the second speaker; and
a controller configured to apply at least one speaker attribute to at least one of the first speaker and second speaker based on the speaker displacement.

2. The device of claim 1, wherein the at least one sensor is further configured to detect a length of the head support.

3. The device of claim 1, wherein the at least one sensor is further configured to detect an angular displacement of an earpiece housing one of the first speaker and the second speaker.

4. The device of claim 1, wherein the at least one sensor is a gyroscope configured to detect an angular displacement of an earpiece housing one of the first speaker and the second speaker.

5. The device of claim 4, wherein the controller is further configured to select the at least one speaker attribute based on a profile associated with the speaker displacement, wherein the profile includes a stored displacement value.

6. The device of claim 5, wherein the at least one speaker attribute includes at least one of an equalization profile, a volume level, and a gain table.

7. The device of claim 5, wherein the controller is further configured to receive a command indicative of a hearing ability of a user and to generate at least one personalized profile based on the command and on the speaker displacement.

8. A headphone listening device, comprising:
a plurality of speakers;
a sensor configured to generate a first sensor value indicative of a head size of a user; and
a controller configured to:
compare the first sensor value to a stored sensor value; and
apply at least one speaker setting associated with the stored sensor value in response to the first sensor value matching the stored sensor value.

9. The device of claim 8, wherein the controller is further configured to receive a command indicative of a hearing ability of a user and to generate at least one personalized profile based on the commands and the sensor value.

10. The device of claim 8, wherein the sensor includes at least one gyroscope configured to detect an angular offset of at least one of the speakers.

11. The device of claim 9, wherein the sensor includes at least one position sensor configured to detect a length of a head support of the headphone listening device.

12. The device of claim 8, wherein the at least one speaker setting includes at least one of an equalization profile, a volume level, and a gain table.

13. The device of claim 8, further comprising a database including the at least one speaker setting associated with the stored sensor value and wherein the database is configured to maintain a plurality of profiles cataloged by a stored sensor value.

14. A non-transitory computer-readable medium tangibly embodying computer-executable instructions of a software program, the software program being executable by a processor of a computing device to provide operations, comprising:
receiving a first sensor value;
comparing the first sensor value with a stored sensor value;
selecting a profile associated to the store sensor value in response to the first sensor value matching the stored sensor value; and
transmitted at least one speaker setting defined by the profile of the stored sensor value.

15. The medium of claim 14, wherein the sensor value is an angular offset of an earpiece.

16. The medium of claim 14, wherein the sensor value is indicative of a length of a head support.

17. The medium of claim 16, wherein the length of the head support is indicative of a user age and hearing ability.

18. The medium of claim 17, wherein the at least one speaker setting includes a maximum volume corresponding to the user age.

19. The medium of claim 14, wherein the at least one speaker setting includes at least one of an equalization profile, a volume level, and a gain table.

20. The medium of claim 14, further comprising receiving a command indicative of a hearing ability of a user and generating at least one personalized profile based on the commands and the sensor value.

21. A headphone listening device, comprising:
a first speaker and a second speaker interconnected by a head support;
at least one sensor configured to detect a speaker displacement of the first speaker relative to the second speaker; and
a controller configured to apply at least one speaker attribute to at least one of the first speaker and second speaker based on a profile associated with the speaker displacement.
